(19) United States
(12) Patent Application Publication
(10) Pub. No.: US 2004/0174998 A1
(43) Pub. Date: Sep. 9, 2004

(54) System and method for data encryption

(75) Inventors: David P. Youatt, Redmond, WA (US); Jason M. Smith, Redmond, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: xSides Corporation, Seattle, WA

(21) Appl. No.: 10/384,147

(22) Filed: Mar. 5, 2003

(51) Int. Cl. H04N 7/167

(52) U.S. Cl. 380/210

(57) ABSTRACT

An encryption technology uses an encryption map and video graphics processing technology to combine an encryption map with the image data. Video image processing using maps, such as texture maps, bump maps and the like are combined with an encryption map to generate and encrypted image data. The image is subsequently decrypted using encryption keys that are combined with the encrypted image data using video graphics processing technologies. The decryption map is combined with the encrypted signal to generate a viewable image. The encryption keys may be on a per pixel basis with a separate encryption key for each pixel. Alternatively, an encryption key may contain active keys that may be used to decrypt more than one pixel as well as decoy keys that do not decrypt the signal and thus confound unauthorized decryption attempts. Using encryption maps, single video frames or portions of video frames may be encrypted. The encryption maps may be used with scaled image data and with two dimensional or three dimensional graphics processors.

### BACKGROUND OF THE INVENTION

1. Field of the Invention

The present invention relates to a method and system for encrypting and decrypting graphical or video data in digital form on a general purpose or specialized computer system, or other player device.

2. Description of the Related Art

The desire of content providers to protect their creations from piracy and other unauthorized use is well established. The use of digital data as the media for distributing content make the need for protection even more acute, given the ease with which digital data can be duplicated and distributed. In particular, the RIAA and MPAA are very interested in protecting film and video content distributed in digital form.

Previous attempts to scramble video signals have not been entirely successful. For example, a commonly used technique involves attenuation of video sync signals, which results in an unstable video image. However, it is possible for unauthorized users to restore the sync signals and thereby stabilize the video image. Thus, the scrambling technique has not proved entirely satisfactory. Some data encryption techniques require significant processing time and are thus not satisfactory for real-time video decryption. Therefore, it can be appreciated that there is a significant need for a system and method that will permit encryption and decryption of video signals. The present invention provides this and other advantages as will be apparent from the following details description and accompanying figures.

### BRIEF SUMMARY OF THE INVENTION

The present invention is embodied in a system and method for encryption/decryption of image data. In one embodiment, a system for processing image data for display on a video display device comprises a first storage area to store input image data corresponding to at least a portion of a video frame. An encryption map reversibly encrypts the input image data and a graphics processor processes the input image data and the encryption map to thereby generate encrypted output image data. In one embodiment, the encryption map comprises encryption key data. The input image data comprises a plurality of pixels and, in one embodiment, the encryption map has an encryption key corresponding to each respective pixel of the input image data with a graphics processor encrypting each of the pixels using the corresponding encryption key. In an alternative embodiment, the input image data comprises a plurality of pixels and the encryption map has an encryption key corresponding to a plurality of the pixels of the input image data with a graphics processor encrypting each of the pixels using the corresponding encryption key. In yet another alternative of embodiment, the input image comprises a plurality of pixels and the encryption map has a plurality of storage locations corresponding to each of the plurality of pixels in the input image data and contains active encryption data in at least one location in the encryption map with the remaining locations in the encryption map containing decoy encryption data not used to encrypt the input image data.

In one embodiment where the input image data comprises a plurality of video scan lines, the encryption map contains an encryption key corresponding to each of the scanned lines in the input image data with the graphics processor encrypting each of the scanned lines using the corresponding encryption key. Where the input image data is a sequence of video frames, each comprising a plurality of pixels, the encryption map may comprise a plurality of encryption maps corresponding to the respective video frames wherein each encryption map has an encryption key corresponding to each respective pixel of the corresponding video frame. Alternatively, a plurality of encryption maps corresponding to respective video frames may contain an encryption key corresponding to a plurality of pixels of the corresponding video frame. In yet another alternative embodiment, an encryption map may be used to encode more than one of a sequence of video frames.

The video frame may also be compressed in accordance with a motion pictures expert group (MPEG) standard wherein the graphics processor processes the MPEG compressed video frame in the encryption map to thereby generate encrypted output image data. The input image data may comprise a sequence of video frames compressed in accordance with MPEG standards wherein the graphics processor processes the MPEG compressed video frames in the encryption map to thereby generate encrypted output image data.

In another embodiment, a system for processing encrypted image data comprises a first storage area to store encrypted input image data corresponding to at least a portion of the video frame and an encryption map containing data for reversibly decrypting the encrypted image input data. A graphics processor processes the encryption map and the encoded input image data to thereby generate decrypted output image data.

In one embodiment, the encryption map data is encryption key data. In one embodiment, the encryption input image data comprises a plurality of pixels and the encryption map has a decryption key corresponding to each respective pixel of the input image data. The graphics processor decrypts each of the pixels using the corresponding decryption key. In one embodiment the encryption input image data comprises a plurality of pixels and the encryption map has a decryption key corresponding to a plurality of pixels in the input image data. In yet another alternative embodiment, the encryption map has plurality of storage locations corresponding to each of the plurality of pixels in the input image data and contains active decryption data in at least one location in the encryption map, with the remaining locations in the encryption map containing decoy decryption data. The active decryption data may be stored in a predetermined one of the plurality of locations within the encryption map. Alternatively, the active decryption data in the at least one location is stored in a pseudo-random one of the plurality of locations in the encryption map.

In one embodiment, the encrypted input image data comprises a plurality of pixels and the encryption map has a plurality of storage locations corresponding to each of the pixels in the input image data. The graphics processor determines decryption data for the remaining locations in the encryption map and decrypts each of the pixels using the corresponding decryption data.

### BRIEF DESCRIPTION OF THE SEVERAL VIEWS OF THE DRAWING(S)

FIG. 1 is a functional block diagram of a typical computer implementing the teachings of the present disclosure.

FIG. 2 is a more detailed functional block diagram of a video controller, such as may be used in the computer system of FIG. 1.

FIG. 3 is a high-level flow chart illustrating data encryption in accordance with the present teachings.

FIG. 4 is a high-level flow chart illustrating data decryption in accordance with the present teachings.

FIG. 5 illustrates the use of encryption mapping on a per-pixel basis.

FIG. 6 illustrates encryption mapping with encryption keys stored at selected locations.

FIG. 7 illustrates encryption mapping with encryption keys stored at selected locations and additional data processing to derive encryption keys.

FIG. 8 illustrates the use of transforms for encryption mapping and scaling.

FIG. 9 is a flow chart illustrating the use of encryption mapping in a typical simple 2D graphics or video device implemented in accordance with the present teachings.

FIG. 10 is a flow chart illustrating image scaling with encryption map scaling in a typical simple 2D graphics or video device implemented in accordance with the present teachings.

FIG. 11 is a flow chart illustrating image scaling with encryption map scaling to de-interlace image data.

FIG. 12 is a flow chart illustrating data flow of a typical computer 3D graphics device implemented in accordance with the present teachings.

FIG. 13 illustrates the combination of texture mapping and encryption mapping with three dimensional rendering.

FIG. 14 is a flow chart illustrating the processing of MPEG data in accordance with the present teachings.

### DETAILED DESCRIPTION OF THE INVENTION

This patent describes various techniques for implementing encryption for digital video images using variations of ideas as well as new hardware from general computer graphics technology. The general technique described is related to rendering a single image, but can easily be implemented to secure or protect a sequence of images and may be integrated with compression techniques from the DCT family (e.g., MPEG), wavelet or fractal technologies.

The techniques described also facilitate an important characteristic of data encryption—separation of encrypted data from the corresponding encryption keys. Such techniques enhance security by eliminating a known weakness in current encryption technologies.

The techniques described herein also facilitate protection of portions of the content, where the portions of the content protected may be determined by spatial, temporal or both spatial and temporal parameters. For example, using the teachings described herein, implementations may be created to permit viewing of only movie trailers or other advertisements, or it may be possible to view the main movie without any ads. It is also possible to block portions of a single frame or portions of each frame in a sequence of frames and thereby implement ratings control for a movie depending on the license key data provided. If the techniques are integrated with image scaling, for example, an implementation may prevent unauthorized modification by resizing of the image or sequence of images.

The system and method described are variations on techniques used in computer graphics to increase realism of rendered scenes—mapping techniques (e.g., texture, bump, displacement, reflection and other mapping types). This, combined with relatively new hardware support for per-vertex and per-pixel programmable “shaders” from vendors such as nVidia (where the technology was originally called “register combiners”) and ATI Technologies, provide the starting point for implementing encryption maps.

The computer graphics literature is rich with papers and articles on implementing and using texture and other mapping techniques to improve the realism of rendered pictures. See, for example, the paper from SGI “Texture Mapping as a Fundamental Drawing Primitive”. Pixar's Renderman rendering language system makes extensive of mapping techniques to produce realistic-looking images without resorting to ray-tracing, radiosity and other, more computationally-intensive rendering techniques.

Cabral's “Accelerated Volume Rendering and Tomographic Reconstruction Using Texture Mapping Hardware” is an example of using mapping techniques, in this case, texture mapping, for other known uses.

Mapping techniques are computationally intensive and require high memory bandwidth to achieve real-time or near real-time rendering rates. Not long ago, hardware support for texture and other mapping techniques was limited to a few “high-end”, expensive workstations; see for example Akeley and Jermoluk, “High-performance Polygon Rendering”, and Akeley, et al, “Reality Engine Graphics”. The more advanced of those workstations provided dedicated per-pixel memory at depths of 128 bits and more, divided among color components, depth(z- and w-) buffering, texture map, stencil planes, alpha buffer, and other specialized memory bits.

Hardware support for texture mapping has become relatively common in low-cost PC graphics cards over the last few years. This has been driven mainly by video and computer game technology that requires high interactivity and low polygon count together with texture mapping to provide more and more realistic game experiences.

In the last couple of years, “high-end”, but still relatively low-priced PC graphics cards have begun to support programmability, perhaps starting with nVidia's “register combiners” in their recent chips. These powerful graphic processing units are sometimes referred to as “programmable shaders” and are capable of executing small programs for each pixel, thus allowing complex operations on a per-pixel basis. Graphics processor manufacturers, such as nVidia and ATI Technologies, have influenced Microsoft to support programmable shaders in recent versions of DirectX, although with different interfaces and in different revisions of DirectX 8.x. Industry groups are also pushing for system compatibility and graphics languages (GL). OpenGL supports the same functions, and perhaps more, through the OpenGL extension mechanism.

Programmable graphics hardware is being supported by traditional language techniques via the proposed OpenGL 2.0 compiler “gislang”, nVidia's Cg graphics programming language, as well as Microsoft's DirectX 8, 9, and 10 programmable shaders.

Given the many applications of texture and other maps, the introduction of per-vertex and per-pixel shaders supported by increasing computing power and memory on graphics cards and chips—in some cases more power and memory than are in the computer itself—together with the desire. to protect digital image and video data, as well as provide levels of access, the techniques described herein utilize programmable shaders to implement decryption functions and to create a new type of map called an encoding map or encryption map. The encryption map is analogous to a texture map and the programmable “shaders” implement a decryption function. Note that an implementation may choose to combine the decryption method to a particular implementation of shaders, perhaps a proprietary version obtained directly from the graphics card or chip vendor, ATI or nVidia, for example.

The new hardware support also provides the opportunity for dynamically changing encryption algorithms as new and better encryption algorithms are developed, as well as for when older algorithms are broken. Various implementations also permit the use of different encryption algorithms for each frame or for ranges of frames to further enhance security. Alternatively, a vendor may choose to implement a proprietary encryption algorithm.

Encryption algorithms use keys ranging from approximately 56 bits to 256 bits and perhaps more. For example, the well-known Data Encryption Standard (DES) uses 56-bit keys; the Advanced Encryption Standard (AES) (Rijndael) uses 128-bit keys by default, but can use longer keys of 192-bits and 256-bits. This is generally deeper than per-pixel bit depths (e.g., 128 bits per pixel) in current graphics cards. Newer graphics cards or custom implementations based on chips from may choose to provide additional memory dedicated to encryption maps, and/or memory in addition to texture memory. They may also choose to provide data paths and/or connections to external memory such as removable CompactFlash memory, or an external network connection dedicated to streaming keys over a broadband network connection, or to a built-in hard disk drive like found in current game consoles or personal video recorders.

As noted above, using the “programmable shader” functionality of current PC graphics/video cards and chips offers the advantage of programmability, so an implementation is not tied to a particular encryption or DSP chip or technology. It may also reduce the chip count in a system.

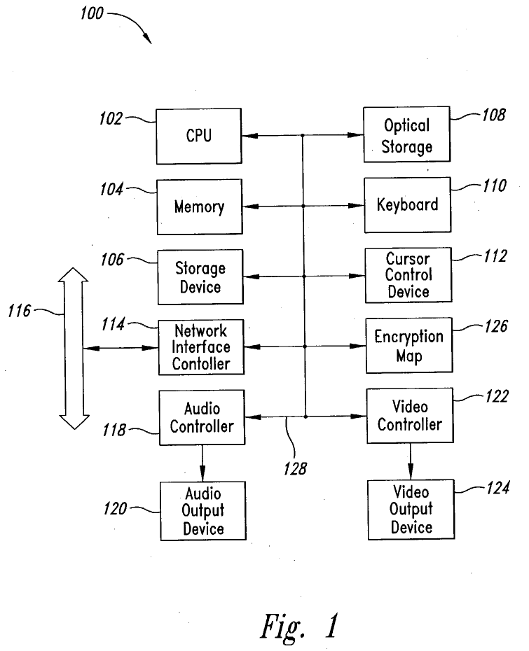

FIG. 1 is a functional block diagram of a conventional computer system containing components used to implement encryption maps, such as described herein. A typical system 100 contains a central processing unit (CPU) 102 and a memory 104. The CPU 102 may be implemented by a variety of known devices, such as conventional microprocessors, microcontrollers, digital signal processors, and the like. The present invention is not limited by the specific device used to implement the CPU 102. Similarly, the memory 104 may also be implemented using a variety of known technologies. The memory 104 may include random access memory (RAM), read-only memory, flash memory, and the like. A portion of the memory 104 may be in the form of a removable memory stick, memory pack, or the like. For the sake of convenience, the different memory types are illustrated in the functional block diagram of FIG. 1 as the memory 104. The memory 104 provides instructions and data for processing by the CPU 102.

The system 100 also includes a storage device 106, such as a hard disk drive, or the like. The system 100 may also include an optical storage device 108, such as a CD ROM drive, DVD drive, or the like. The storage device 106 and optical storage device 108 are known in the art and need not be described in greater detail herein. The system 100 also comprises conventional components including a keyboard 110 and cursor control device 112, such as a mouse or joystick.

The system also includes a network interface controller (NIC) 114 that allows communication between the system 100 and a network 116. The network 116 may be a local area network (LAN) or a wide area network (WAN). The specific implementation of the NIC 114 depends on the type of connection to the network 116. For example, the network connection may be a dial-up connection to a WAN, such as the Internet. In this implementation, the NIC 114 may simply be a modem. In an alternative embodiment, the NIC 114 may be an Ethernet controller or other high-speed interface device. In an alternative embodiment, the network 116 may be an optical fiber or cable modem connection. In this embodiment, the NIC 114 is an appropriate interface designed for operation with cable or optical data delivery. The system 100 is not limited by the specific implementation of the NIC 114 nor is it limited by the type of network 116 to which the system 100 is coupled. The operation of the NIC 114 to communicate with the network 116 (either a LAN or a WAN) are known in the art and need not be described in greater detail herein.

The system 100 also includes an audio controller 118 and an audio output device 120. The audio controller may be integrated into a mother board (not shown) containing the CPU 102 or may be implemented as a separate interface board connected to the mother board in a conventional fashion. The audio output device 120 may be readily implemented by conventional speakers, headphones, or the like. The operation of the audio controller 118 and audio output device 120 are known in the art and need not be described in greater detail herein.

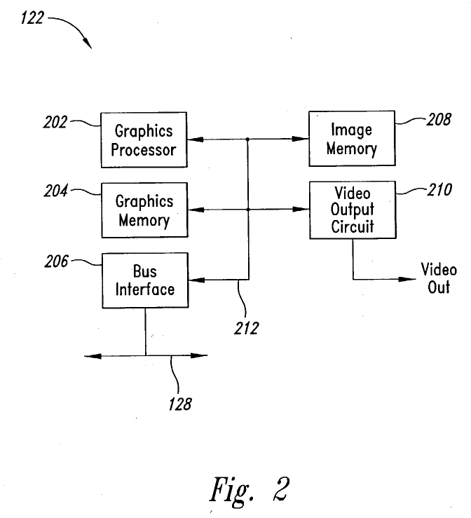

The system 100 illustrated in FIG. 1 also includes a video controller 122 and a video output device 124, such as a flat panel display, video monitor, or the like. Example embodiments of the video controller 122 have been discussed above. Additional details of the video controller 122 and its operation with an encryption map 126 are discussed in greater detail below. The encryption map 126 may be part of the memory 104 or a portion of graphics memory 204 (see FIG. 2) on the video controller 122. In one implementation, the encryption map 126 may be implemented as a removable portion of the memory 104, such as a memory pack or a memory stick. In this manner, the encryption map 126 may readily be removed from the system for increased security.

The components described above are coupled together by a bus system 128. The bus system 128 may include a data bus, address bus, control bus, power bus, and the like. For the sake of clarity, the various busses are described herein as the bus system 128.

FIG. 2 is a functional block diagram illustrating additional details of a typical video controller 122. The video controller 122 comprises a graphics processing unit (GPU) 202 and a graphics memory 204. The GPU 202 may be implemented by a conventional microprocessor, microcontroller, digital signal processor, or the like. Graphics processing units are often specially designed for high-speed processing of video data and, in many cases, have clock speeds and data rates greater than a conventional CPU (e.g., the CPU 102 of FIG. 1).

The GPU 202 processes image or video data that may be received from a number of different sources, such as the CPU 102 via the bus system 128 or via a special high-speed data bus sometimes referred to as an advanced graphics port (AGP). The graphics data processed by the GPU 202 may be individual images or a stream of images, such as video data. For the sake of convenience, the data will be referred to herein as image data. However, those skilled in the art will recognize that this term is not limited to any particular form of graphics data. Image data may be supplied directly from the memory 104, the storage device 106 or the optical storage device 108. In addition, the video data may be supplied to the GPU 202 from the network 116 using real-time multimedia streaming technology.

The graphics memory 204 is implemented using conventional high-speed memory technology. The graphics memory 204 provides data and instructions for processing by the GPU 202. Data provided by the graphics memory 204 may include, by way of example, texture maps, bump maps and the like. In addition, the encryption map 126, illustrated in FIG. 1, may be physically implemented in the graphics memory 204.

A bus interface 206 couples the video controller 122 to the bus system 128. As noted above, the bus system 128 may include the AGP to provide high-speed data transfer to the video controller 122.

The video controller 122 typically includes an image memory 208 that stores one or more processed video frames. The processing may include implementation of texture maps, bump maps, and the like as well as the addition of the encryption map 126. A video output circuit 210 receives the data from the image memory 208 and generates the necessary video output signals for connection to the video output device 124 (see FIG. 1). The video output circuit 210 typically generates the necessary synchronization signals as well as standardized video output signals. The generation of the necessary video control signals is well known in the art and need not be described in greater detail herein.

The various components of the video controller 122 are coupled together by a graphics bus system 212. The graphics bus system 212 may contain address bus, data bus, control bus, power bus, and the like. For the sake of clarity, these various busses are illustrated in FIG. 2 as the graphics bus system 212.

Both the encryption and decryption process will be described herein. In an exemplary embodiment, described herein, the encryption and decryption process are symmetrical. That is, the encryption key and decryption key are identical. However, those skilled in the art will recognize that the system may be satisfactorily implemented with other encryption processes. For example, the public/private encryption key process can be used to encrypt and decrypt image data.

The encryption process (i.e., encrypting a viewable image or series of images) may typically be performed by a manufacturer or service provider. For example, a pay-per-view television movie may be encrypted by the service provider and transmitted to the user in an encrypted form. As such, the image may not be viewed unless properly decrypted. This may prevent unauthorized acquisition of movies or may be used to implement a rating system to prevent minors from viewing objectionable material.

The decryption process is typically performed by the end-user just prior to viewing the image or image sequence. As those skilled in the art can appreciate, the decryption process may be implemented on a personal computer coupled to a video monitor or by a graphics processing device to decrypt, by way of example, video images provided via satellite, cable, over-the-air broadcast, or the like. The present invention is not limited by the particular media used to provide the image data to the end-user.

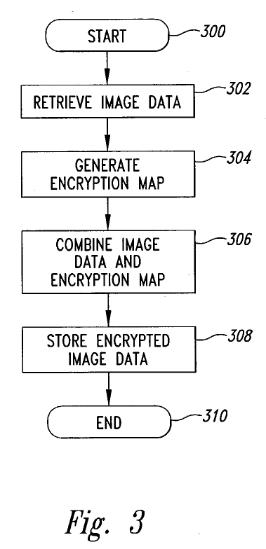

FIG. 3 is a high-level flowchart illustrating the encryption operation. At a start 300, a system, such as the system 100 illustrated in FIG. 1, is initialized in operating. In step 302, the system retrieves the image data. As those skilled in the art will appreciate, the image data may be provided by a variety of sources. For example, the image data may be provided from an application program wherein the image data resides in the memory 104. Alternatively, the image data may be provided by the storage device 106, the optical storage device 108, or from the network 116 via the NIC 114. As noted above, the image data may be in the form of a still image, a sequence of images, or a streaming image, such as a video signal.

In step 304, the encryption map is generated. In step 306, the system 100 combines the image data and the encryption map. In step 308, the system 100 stores the encrypted image data and the process ends at 310.

The steps of generating the encryption map (i.e., step 304) and combining the image data and the encryption map (i.e., step 306) can be implemented in a variety of different manners. In one embodiment, the encryption map 126 (see FIG. 1) may simply contain random or pseudo-random numbers that are simply combined with the existing image data. The combination may be generated using simple additive or logical combinative techniques known in the art. If the encryption map 126 is a random number map, the decryption process would simply use the same map to “uncombine” the encryption map from the encrypted image data to thereby restore the original image data. If the encryption map is a pseudo-random noise sequence, the decryption process may utilize the pseudo-random map or simply utilize the seed use to initialize the pseudo-random number generator. In an alternative embodiment, the encryption map 126 is a white noise map that is combined with the image data in the manner described above. The reverse decoding process simply uses the same map to uncombine the encryption map 126 from the encrypted image data to thereby restore the original image data.

In a more complex operation, the encryption map 126 may contain one or more encryption keys that are used to encrypt the data in accordance with conventional standards, such as DES or AES. Thus, the term “encryption map” as used herein refers to any data set that is applied to image data to thereby render the image data invalid or unintelligible. This is a reversible process with the inverse process decrypting the invalid or unintelligible image data to thereby restore the original image data.

As noted above, some video controllers contain a GPU 202 (see FIG. 2) capable of executing software routines on a per-pixel basis. That is, the GPU may perform an encryption routine using conventional encryption technology for each and every pixel of image data such that each pixel is separately encrypted and has an individual encryption key. In this embodiment, the encryption map 126 (see FIG. 1) is a set of one or more encryption keys. Thus, the GPU 202 generates a composite digital image where one image is an encryption bitmap or an encryption map. This is similar to alpha blending where one of either the source or destination map is the encryption map 126. Traditional image blending/compositing uses simple logic or arithmetic operations on each pixel to combine two or more images into a single new image. In this example, the encryption map is a bitmap having an encryption key corresponding to each pixel in the video image. Alternatively, predetermined regions of the encrypted image may share a single encryption key. In this embodiment, other entries in the encryption map 126 may be unused decoy encryption keys to further confound any attempts to decrypt the video image.

In yet another alternative embodiment, each scan line in the rasterized video image is encrypted using a separate key. Again, additional keys in the encryption map 126 may be decoy keys that are not used in the actual decryption process. In yet another alternative embodiment, sequences of frames (e.g., video clips, movies, and the like) can be encrypted such that only selected frames may be viewed. The examples presented above are just a few of the many possible techniques where encryption maps can be used to encrypt image data. Other applications are encryption maps should be considered within the scope of the present invention.

An advantage to encrypting graphical data for subsequent decryption using encryption maps is that there are multiple “keys” for the content to be secured. Depending on the embodiment, there could be one or more keys for a single frame, or the same keys reused for multiple frames. In either case, since there are multiple, different keys for the entire content. If one key is compromised only a portion of the media content is compromised.

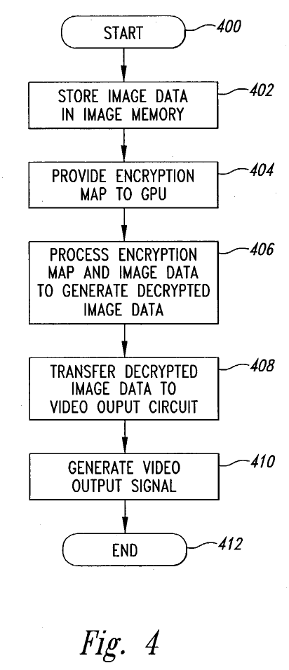

A high-level decryption flow chart is illustrated in FIG. 4. The decryption process utilizes many of the same components of the system 100 illustrated in the functional block diagram of FIG. 1. A significant difference is that the encryption map 126 is used for decryption rather than encryption. Encryption keys are provided to the system to permit decryption of an already encrypted image. At a start 400, one or more frames of image data have already been encrypted, as discussed above. In step 402, one or more frames of the encrypted image data are stored in the image memory 208 (see FIG. 2). Even though the image memory 208 may contain more than one video frame, the GPU 202 typically processes one frame of data at a time. In step 404, the encryption keys are also provided to the GPU 202. The encryption keys will permit decryption of the encrypted image data.

In step 406, the GPU 202 processes the encrypted image data with the encryption keys in a manner similar to processing data using, by way of example, a programmable shader, to implement the decryption process. As will be discussed in greater detail, implementation such as a programmable shader can operate on a per-pixel basis or a per-vertex basis to generate the decrypted image. In step 408, a viewable image (i.e., a decrypted image) is provided to the video output circuit 210 (see FIG. 2). It should be noted that the decrypted image may also be temporarily stored in the image memory 208 for extraction by the video output circuit 210.

The decrypted video output signal is provided to the video output device in step 410 and the process ends at 412 with a single frame of video data having been decrypted and provided to the video output device. The process is repeated on a frame-by-frame basis and can be performed in real time to fully decrypt data provided from sources, such as a DVD or real-time video streaming source.

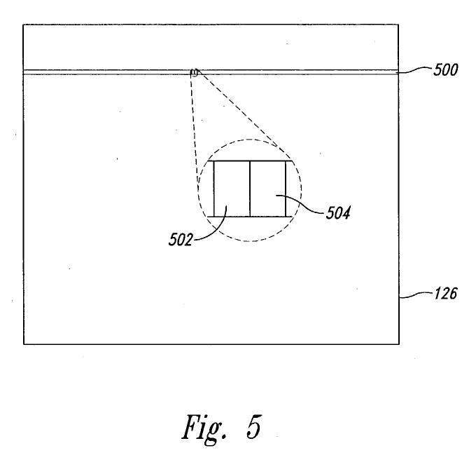

FIGS. 5-7 illustrate some possible implementations of the encryption maps. In the example illustrated in FIG. 5, each pixel is individually encrypted. As those skilled in the art appreciate, a graphic image is typically represented as a plurality of pixels arranged in an array. When one describes a screen area as having, by way of example, 1,024×768, it refers to the number of pixels in the screen array. In this example, each of 768 horizontal scan lines contains 1,024 pixels.

Those skilled in the art will recognize that the encryption map 126 can be physically arranged for convenient and efficient storage. For simplicity in comprehending the invention, the encryption map 126 is illustrated in FIG. 5 as having the same physical layout as the image data. That is, the encryption map 126 in FIG. 5 is illustrated as a series as scan lines each having a number of pixels corresponding to the resolution of the image data. For the sake of simplicity, only a single scan line 500 is illustrated in FIG. 5. In a magnified portion of the scan line 500 pixels 502 and 504 are illustrated. In this example, the data associated with pixel 502 is an encryption key used to encrypt and decrypt the image data in the corresponding pixel. Similarly, the data associated with the pixel 504 in the encryption map 126 is used to encrypt and decrypt the image data in the corresponding pixel. In this embodiment, the encryption map 126 contains a separate encryption code (i.e., an encryption key) corresponding to each pixel in a set of image data such that each pixel is separately encrypted. The corresponding decryption map would also have a decryption key for each individual pixel in the image data. In this example there is a one-to-one correspondence between the pixels in the image data and the pixels in the encryption map 126.

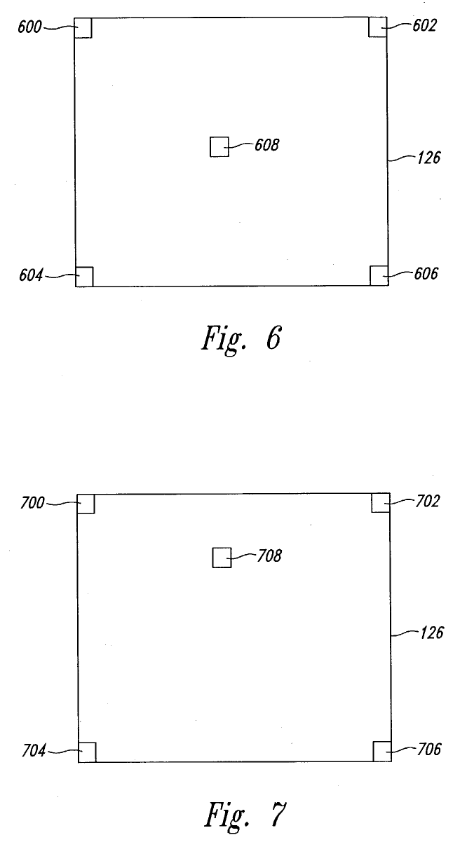

FIG. 6 illustrates an encryption/decryption map wherein multiple pixels of the image data are encrypted using a common key. In the embodiment illustrated in FIG. 6, the encryption map 126 has the same resolution (i.e., number of pixels) as the image data, but with the actual encryption keys being stored in one or more predetermined locations, or at a pseudo-random location within the encryption map 126. Thus, unauthorized attempts to decrypt the image data are further confounded by the inability to determine which of the numerous pixels in an encryption map are the actual encryption keys.

For ease in comprehending the invention, the encryption map 126 in FIG. 6 is illustrated as having a layout similar to the image data. FIG. 6 illustrates pixels 600-606 corresponding to the corners of the image data. The encryption keys may be stored at a predetermined location within the encryption map 126, such as one or more corner pixels 600-606. In one embodiment, four separate encryption keys are stored at the corner pixels 600-606, respectively, of the encryption map 126. In this example, the decryption process requires the four separate keys that must be acquired to successfully decrypt a particular frame of image data. Alternatively, the four corner pixels 600-606 may each contain a portion of a single encryption key. In this example, the four portions of the encryption key are combined in a predetermined manner to derive a single encryption key that is applied to all pixels in a particular frame of image data.

The two examples presented above describe a system in which encryption keys are stored at the corners of the encryption map 126. However, those skilled in the art will recognize that encryption keys may be stored at any known location, such as a pixel 608, in the encryption map 126 or even at a pseudo-random location. If a pseudo-random location within the encryption map 126 is chosen as the actual encryption key, unauthorized decryption becomes even more difficult without the proper seed for the pseudo-random sequence generation. The process of pseudo-random number generation is known in the art and need not be described in greater detail herein. In one embodiment, the pseudo-random sequence seed may be provided separately from the image data and the encryption map. Alternatively, the encryption map itself may contain the pseudo-random sequence seed. For example, the pseudo-random sequence seed may be contained in an encryption map for the first frame of image data. The pseudo-random location of the encryption keys for subsequent frames is determined by the initial pseudo-random sequence seed.

FIG. 7 illustrates an encryption map in which active encryption keys are stored at one or more predetermined locations in the encryption map 126 and interpolated to provide additional encryption keys. In this embodiment, there may be a one-to-one correspondence between encryption keys in pixels in the image data. However, this example embodiment requires only a few actual encryption keys to be provided to the decryption process. The remaining encryption keys are formulated by interpolation of the limited number of provided encryption keys. As with previous examples, FIG. 7 illustrates the encryption map 126 with a layout designed to correspond to the image data and illustrates individual pixels 700-706 in the corners of the encryption map as well as an additional pixel 708. In the example of FIG. 7, the encryption keys are contained in the data associated with the pixels 700-706. As noted above with respect to FIG. 6, the system may be implemented with a separate encryption key at each of the pixels 700-706, respectively. Alternatively, the pixels 700-706 may each contain a portion of a single encryption key that are combined in a predetermined manner.

In the example of FIG. 7, the GPU 202 (see FIG. 2) derives the encryption keys for the remaining pixels (e.g., the pixel 708) of the encryption map 126 using one or more of a variety of known interpolation processes. For example, it is possible to use known graphics scaling techniques for interpolating data, such as a minimum value, maximum value, nearest value, linear, bilinear or tri-linear interpolation or polynomial interpolation to derive the remaining keys in the encryption map 126. The advantage of this approach is that only a limited number of keys need to be transmitted while the GPU 202 derives the remaining keys using one or more of the interpolation methods described above. Those skilled in the art will appreciate that it must be known in advance which interpolation technique was used during the encryption process so that the decryption process derives the appropriate keys. That is, if a bilinear interpolation was used in the encryption of image data, the same bilinear interpolation process must be used in the decryption process to successfully decrypt the image data.

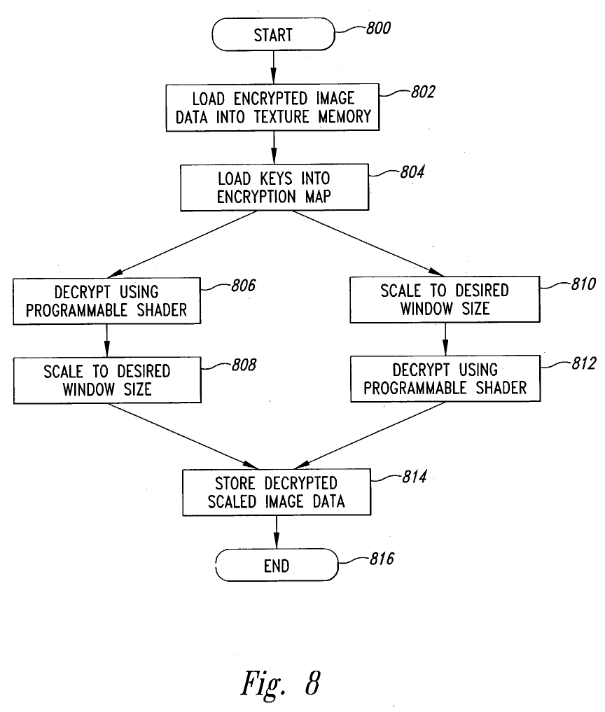

The system 100 is capable of processing encryption maps with two dimensional or three dimensional images and can also accommodate image scaling, which is common in graphics processing. FIG. 8 is a flow chart illustrating the operation of the system 100 to scale encrypted and decrypted image data. At a start 800, the system 100 is operational. At step 802, the GPU 202 (see FIG. 2) loads the encrypted image data into texture memory. In step 804, the system 200 loads keys into the encryption map 126. At this point, the encrypted image may be decrypted and then scaled or may be scaled and decrypted. For the former process, step 806 decrypts the encrypted image data using, by way of example, the programmable shader processing capability of the GPU 202. Following decryption, the decrypted image data may be scaled to the desired window size in step 808 using conventional techniques that need not be described in any detail herein.

For the latter process (i.e., scaling followed by decryption), the encrypted image and the encryption map are both scaled to the desired window size in step 810. Scaling both the image data and the encryption map using the same scaling process assures reliable subsequent decryption. In step 812, the GPU 202 (see FIG. 2) decrypts the scaled image data using the scaled encryption map.

Following the operation of step 808 to scale the decrypted image or step 812 to decrypt the scaled image, the scaled decrypted image data is stored in a buffer, such as the image memory 208 (see FIG. 2) in step 814 and the process ends at 816.

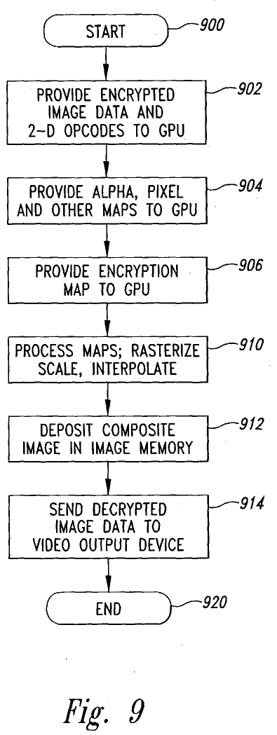

FIG. 9 is a high-level diagram illustrating the decryption processing of a simple two-dimensional image along with the encryption map 126 (see FIG. 1). At a start 900, the system 100 (see FIG. 1) is under power and initialized. In step 902, the encrypted image data and limited two-dimensional opcodes are provided to the GPU 202. The encrypted image data and opcodes may be provided via the CPU 102, or directly provided from the memory 104 using direct memory access techniques. Alternatively, the image data and opcodes may be provided via the storage device 106, the optical storage device 108 or as a streaming media signal from the network 116.

In step 904, alphanumeric maps, pixel maps, and other maps are provided to the GPU 202. In step 906, the encryption map 126 (see FIG. 1) is provided to the GPU 202. Example implementations of the encryption map 126 have been discussed above.

In step 910, the GPU 202 combines the encrypted image data, two-dimensional opcodes, alphanumeric, pixel, and other maps, along with the encryption map 126 (see FIG. 1). The GPU 202 rasterizes the data and may further scale the video data and interpolate the video data to thereby generate a composite image. In step 912, the composited image is temporarily stored in the image memory 208 (see FIG. 2) and provided to the video output device 124 in step 914. The process ends at 920 with one or more frames of image data being decrypted using the encryption map 126 and delivered to the video output device 124.

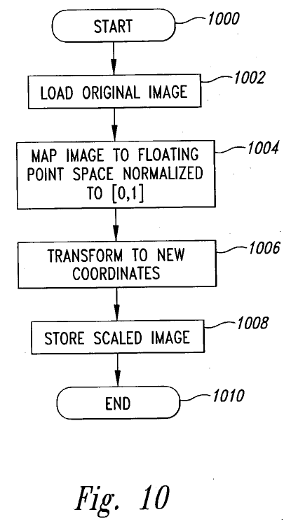

FIG. 10 illustrates the operation of the system 100 for scaling a two dimensional image. If the image data is decrypted prior to scaling, conventional techniques are used to scale the decrypted image. This process is known in the art and need not be described in greater detail herein. However, the system 100 is capable of scaling the encrypted image. This process is illustrated in FIG. 10 where, at a start 1000, the system 100 is operational. In step 1002, the system 100 loads the original encrypted image. In step 1004, the GPU 202 (see FIG. 2) maps the image to a floating point space that is normalized to have values ranging from 0 to 1. That is, the original image is scaled to coordinates having values between 0, 0, and 1, 1. In addition, the encryption map 126 is also normalized in a corresponding fashion. In this manner, the appropriate encryption keys for the pixels in the encryption map 126 will still correspond to the pixels of the final scaled image.

In step 1006, the GPU 202 (see FIG. 2) transforms the floating point coordinates to the new coordinates. Similarly, the floating point data corresponding to the encryption map 126 is also transformed to the new coordinates. For example, if the original image is 486×720 and is scaled to NTSC resolution of 525×858 requires scaling in both the X and Y dimensions. By scaling the encryption map by the same factors, the scaled encryption map will still correspond to the pixels of the scaled encrypted image. The decryption process may proceed as discussed above using the scaled encryption map and the scaled encrypted image data.

The transformation to NTSC resolution is simply one example of the scaling process performed by the system 100. Scaling to other resolutions may be performed in a similar manner. For example, an industry standard, PAL, has a resolution of 625×864 pixels. In the example above where the original image has a resolution of 486×720, a different scaling factor would apply when the original image data and original encryption map are transformed to floating point space in step 1004.

In step 1008, the system 100 stores the scaled encrypted image and the process ends at 1010. Decryption of the scaled image occurs in a manner already described.

A video image is often presented as two interlaced fields that are combined visually to present a single frame at one-half the field rate. Video programs using the NTSC or PAL standards are interlaced. Each frame consists of two fields that are displayed in two passes. For example, one NPSC video frame is displayed approximately every 1/30th of a second and contains two interlaced fields, which are displayed approximately every 1/60th of a second. The two fields that comprise a single frame are sometimes referred to as even and odd fields. These interlaced fields resulted from early technology that was incapable of high video frame rates.

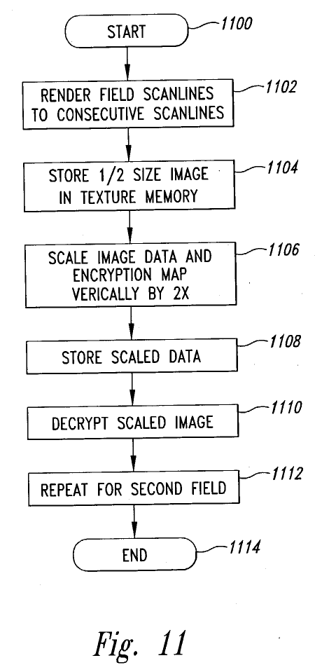

Most computers are capable of higher frame rates and are not limited by the outdated technology. The typical computer display (e.g. the video output device 124 of FIG. 1) uses a progressive scan in which all lines of a frame are displayed in a single pass. However, some video input signals may be provided to the computer in interlaced form. The system 100 is capable of scaling an interlaced image to effectively de-interlace the image. If the interlaced image is decrypted prior to de-interlacing, the scaling process to de-interlace the image occurs in a conventional fashion that need not be described herein. However, the system 100 is capable of de-interlacing encrypted video frames to permit subsequent decryption of the de-interlaced image. This process is illustrated in the flow chart of FIG. 11 where, at a start 1100, the system 100 is activated. In step 1102, the GPU 202 (see FIG. 2) renders the field scan lines for a first field into consecutive scan lines. As is known in the art, the odd field contains odd numbered scan lines (i.e., 1, 3, 5, . . . ) while the even field contains even scan lines ( i.e., 2, 4, 6, 8 . . . ). In step 1102, the alternating scan lines are converted into consecutive scan lines, which has the effect of shrinking the image vertically by a factor of two.

In step 1104, the half-sized image is stored in texture memory for subsequent processing. If the encryption map 126 provides encryption keys for an entire frame, it will be necessary to extract the portion of the encryption map (i.e., every other scan line) corresponding to the current field being processed. In this manner, the processed encryption map will correspond in size to the selected field. In an alternative embodiment, separate encryption maps are provided for each field. In that event, there is an encryption map corresponding to each of the data fields.

In step 1106, the GPU 202 (see FIG. 2) scales the image data and the corresponding encryption map vertically by a factor of two. The vertical scaling is accomplished by interpolation of the horizontal scan lines. In this manner, the expanded video image now fills the entire screen. At the same time, the encryption map corresponding to the field being processed is also expanded by the same factor using the same interpolation process such that the expanded encryption map now corresponds to the expanded image data.

In step 1108, the GPU 202 stores the scaled data in the image memory 208 for subsequent decryption. Thus, the image memory now stores a complete frame of data rather than an interlaced field. Similarly, the encryption map is also now expanded to correspond to an entire frame of data and has maintained the one-to-one pixel correspondence between the encryption map and the image data.

In step 1110, the GPU 202 (see FIG. 2) decrypts the scaled image in a manner previously described. In step 1112, the process is repeated for the second field and the process ends at 1114. In this manner, the frame rate has been doubled from approximately 30 interlaced frames per second to 60 de-interlaced frames per second. In addition, the encryption map has also been expanded to match the individual de-interlaced frames.

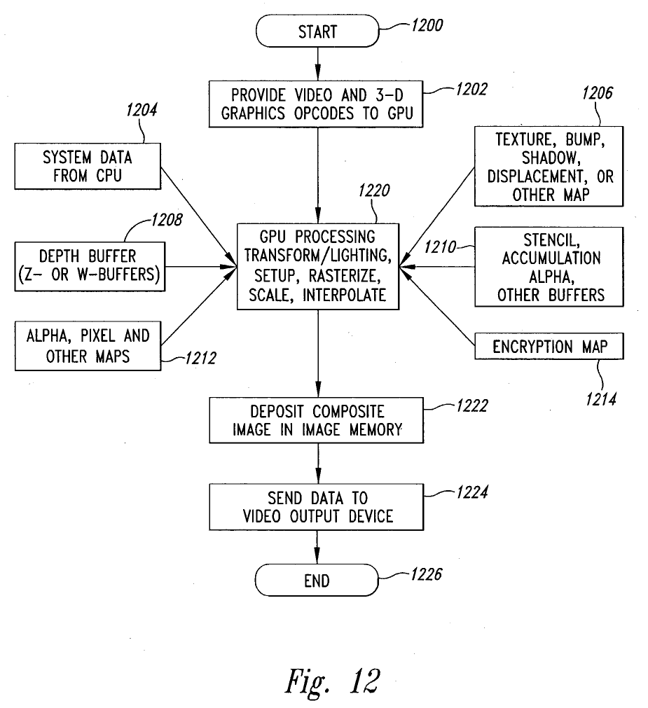

In addition to decryption in scaling of two dimensional images, the system 100 is capable of scaling and decrypting three dimensional images. FIG. 12 is a high-level flow chart illustrating the operation of the system 100 to encrypt three-dimensional images. At a start 1200, the system 100 (see FIG. 1) is under power and initialized. In step 1202, three-dimensional graphic opcodes and data are provided to the GPU 202 (see FIG. 2). In step 1204, the CPU 102 and/or the memory 104 provide the graphic opcodes and video data to the GPU 202. In step 1206, additional three-dimensional maps, such as texture maps, bump maps, displacement maps, shadow maps, or other map memories are provided to the GPU 202. In step 1208, a depth buffer, which is typically part of the graphic memory 204 (see FIG. 2) provides additional data in the form of a z-buffer or a w-buffer. In step 1210, additional buffer data, such as data from a stencil buffer, accumulation buffer, alphanumeric buffer, or the like are provided to the GPU 202. In step 1212, alphanumeric, pixel, and other masks may be provided to the GPU 202.

In step 1214, the data from the encryption map 126 (see FIG. 1) is provided to the GPU 202. In step 1220, the GPU 202 processes all of the received data, including the encryption map 126, using processes such as transformation, lighting, setup, and the like. The GPU 202 rasterizes, scales, and interpolates the data to generate a video image.

In step 1222, the composited image is stored in the image memory 208 (see FIG. 2) and provided to the video output device 124 (see FIG. 1) in step 1224. The process ends at 1226 with an encrypted three-dimensional video image sent to the video output device.

If the video controller 122 is a graphics card, the mapped image appears as a real polygon. For hardware that contains video-only processing with no graphics, a real polygon is not present, but the extents of the polygon are available for the mapping. Following the normalization process, the target image is transformed to screen coordinates having the desired resolution. In the example of an NTSC digital image, the normalized floating point values are transformed to the screen resolution of 858×525 pixels. Additional processing of graphics polygons are known to those of ordinary skill in the art and they need not be described in greater detail herein.

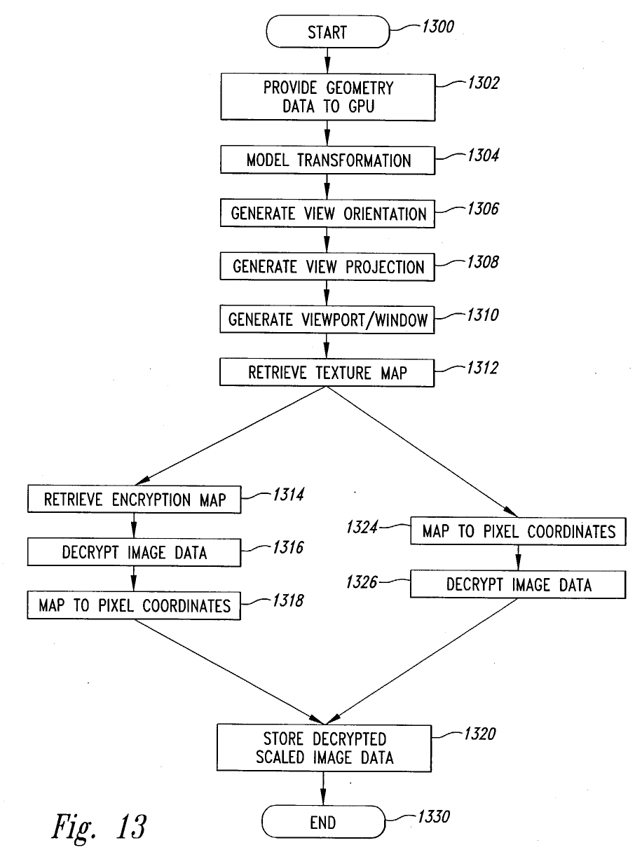

The operation of the system 100 to process three-dimensional images along with texture maps is illustrated in the flow chart of FIG. 13 where, at a start 1300, an image has been created. In step 1302, the image geometry data is provided to the GPU 202 (see FIG. 2). Those skilled in the art of graphics processing will appreciate that the objects on the image are described by geometry data.

In step 1304, the GPU 202 (see FIG. 2) performs a model transformation of the geometry data. In step 1306, the GPU generates a view orientation and in step 1308 generates a view projection. These processing steps are known in the art and need not be described in greater detail herein. In step 1310, the GPU 202 generates viewport/window data. As is known in the art, a viewport defines a portion of pixels in a window that will be visible to the viewer while other pixels may not visible and thus require no additional processing.

In step 1312, the GPU 202 retrieves the texture map. As those skilled in the art will appreciate, the texture map is applied to visible pixels to create a more realistic image. At this point in the process, the GPU 202 may decrypt the image data or scale the encrypted data. If decryption is chosen, the GPU 202 retrieves the encryption map 126 in step 1314. In step 1316, the image data is decrypted in the manner described above. In step 1318, the decrypted image is mapped to pixel coordinates and in step 1320, the GPU 202 stores the decrypted scaled image data in a storage area, such as the image memory 208 (see FIG. 2).

If the GPU performs a scaling operation prior to decryption, the image data is mapped to pixel coordinates in step 1324. In addition, the encryption map is also scaled by the same scaling process to map to the pixel coordinates. In this manner, the scaled encryption map will correspond to the scaled image data. In step 1326, the GPU 202 decrypts the scaled image data using the scaled encryption map 126 and, in step 1320, the GPU stores the decrypted scaled image data. The process ends at 1330 with a frame of 3-D image data having been processed and decrypted by the system 100.

The system 100 is also useful for encrypting and decrypting multimedia data that may be compressed or decompressed in accordance with industry standards. Several such standards have been defined by a motion pictures expert group (MPEG) for compressing audio data, video data, and multimedia data.

Those of ordinary skill in the art will understand the MPEG compression/decompression process, which need not be described in detail herein. However, MPEG compressed video comprises one or more key frames that are compressed without reference to any other video frames. These MPEG I-frames are used as the basis for forward or backward references to other video frames. For example, an MPEG I-frame may be generated at the start of a scene in a movie. A subsequent frame may contain many of the same objects, which need not be recompressed in accordance with MPEG standards. Rather, only differences between the I-frame and the subsequent frame need be compressed, thus decreasing storage requirements. In accordance with MPEG standards, certain frames may look for inter-frame differences in both the forward and the backward direction.

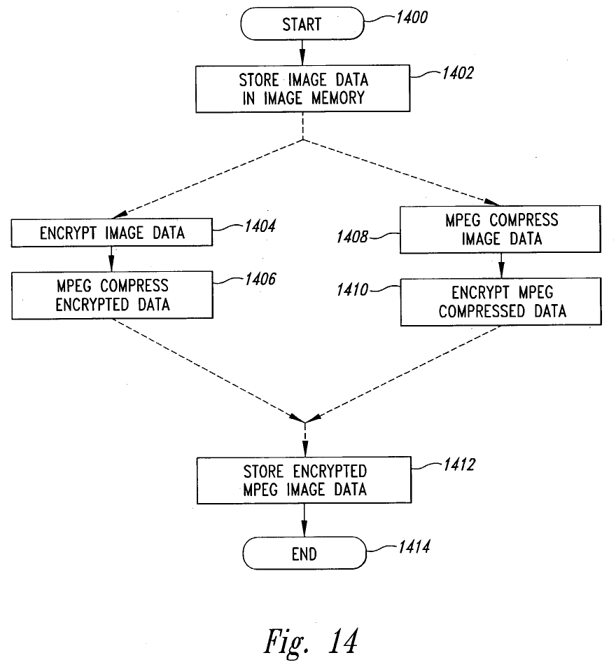

In accordance with the present teachings, the encryption map 126 may be used with MPEG data such that encryption maps are computed either for the MPEG compressed frame(s) or decompressed frame(s). The encryption process for MPEG data is illustrated in the flow chart of FIG. 14 where, at a start 1400, image data has been generated. In step 1402, the image data is stored in image memory 208 (see FIG. 2). The system 100 may alternatively encrypt the image data and then perform MPEG compression or reverse the process.

In step 1404, the GPU 202 (see FIG. 2) encrypts the image data in the manner described above and in step 1406, the encrypted image data is compressed in accordance with MPEG standards. Alternatively, the system 100 may compress the image data in accordance with MPEG standards in step 1408 and, in step 1410, the GPU 202 encrypts the MPEG compressed data.

Following the execution of either step 1406 or 1410, the system 100 stores the encrypted MPEG compressed image data in step 1412 and the process ends at 1414. Those skilled in the art will appreciate that the decryption process is essentially a reverse process to that described above with respect to FIG. 14. For the sake of brevity, that reverse process need not be illustrated herein.

Various combinations of encryption and MPEG compression may also be performed by the system 100. For example, the encryption map 126 (see FIG. 1) can be generated only for MPEG I-frames, or for all MPEG frames. Alternatively, the same encryption map may be used for an MPEG I-frame and all related MPEG frames. In addition, various permutations of these encryption techniques may be used to further confound an unauthorized user.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A system for processing image data for display on a video display device, comprising:
a first storage area to store input image data corresponding to at least a portion of a video frame;
an encryption map to reversibly encrypt the input image data; and
a graphics processor to process the input image data and the encryption map to thereby generate encrypted output image data.

2. The system of claim 1 wherein the encryption map comprises encryption key data.

3. The system of claim 1 wherein the input image data comprises a plurality of pixels and the encryption map has an encryption key corresponding to each respective pixel of the input image data, the graphics processor encrypting each of the pixels using the corresponding encryption key.

4. The system of claim 1 wherein the input image data comprises a plurality of pixels and the encryption map has an encryption key corresponding to a plurality of the pixels of the input image data, the graphics processor encrypting each of the pixels using the corresponding encryption key.

5. The system of claim 1 wherein the input image data comprises a plurality of pixels and the encryption map has a plurality of storage locations corresponding to each of the plurality of pixels in the input image data and contains active encryption data in at least one location in the encryption map, the remaining locations in the encryption map containing decoy encryption data not used to encrypt the input image data.

6. The system of claim 1 wherein the input image data comprises a plurality of video scan lines and the encryption map has an encryption key corresponding to each of the scan lines of the input image data, the graphics processor encrypting each of the scan lines using the corresponding encryption key.

7. The system of claim 1 wherein the input image data is a sequence of video frames each comprising a plurality of pixels and the encryption map comprises a plurality of encryption maps corresponding to the respective video frames wherein each encryption map has an encryption key corresponding to each respective pixel of the corresponding video frame.

8. The system of claim 1 wherein the input image data is a sequence of video frames each comprising a plurality of pixels and the encryption map comprises a plurality of encryption maps corresponding to the respective video frames wherein each encryption map has an encryption key corresponding to a plurality of the pixels of the corresponding video frame.

9. The system of claim 1 wherein the input image data is a sequence of video frames and graphics processor uses the encryption map to encode more than one of the sequence of video frames.

10. The system of claim 1 wherein the video frame is compressed in accordance with a motion pictures expert group (MPEG) standard wherein the graphics processor processes the MPEG compressed video frame and the encryption map to thereby generate encrypted output image data.

11. The system of claim 1 wherein the input image data is a sequence of video frames compressed in accordance with a motion pictures expert group (MPEG) standard wherein the graphics processor processes the MPEG compressed video frames and the encryption map to thereby generate encrypted output image data.

12. The system of claim 1, further comprising a second storage area to store the encrypted output image data and a decryption map to reversibly decrypt the encrypted output image data, wherein the graphics processor further processes the encrypted output image data and the decryption map data to thereby generate decrypted output image data.

13. The system of claim 12 wherein the decryption map is decryption key data.

14. The system of claim 12 wherein the decryption map is identical to the encryption map.

15. The system of claim 12 wherein the encrypted output image data comprises a plurality of pixels and the decryption map has a decryption key corresponding to each respective pixel of the output image data, the graphics processor decrypting each of the pixels using the corresponding decryption key.

16. The system of claim 12 wherein the encrypted output image data comprises a plurality of pixels and the decryption map has a decryption key corresponding to a plurality of the pixels of the encrypted output image data, the graphics processor decrypting each of the pixels using the corresponding decryption key.

17. The system of claim 12 wherein the encrypted output image data comprises a plurality of pixels and the decryption map has a plurality of storage locations corresponding to each of the plurality of pixels in the encrypted output image data and contains active decryption data in at least one location in the decryption map, the remaining locations in the decryption map containing decoy decryption data not used to decrypt the encrypted output image data.

18. The system of claim 17 wherein the active decryption data in the at least one location is stored in a predetermined one of the plurality of locations within the decryption map.

19. The system of claim 17 wherein the active decryption data in the at least one location is stored in a pseudo-random one of the plurality of locations within the decryption map.

20. The system of claim 12 wherein the encrypted output image data comprises a plurality of pixels and the decryption map has a plurality of storage locations corresponding to each of the plurality of pixels in the output image data and contains active decryption data in at least one location in the decryption map, the graphics processor determining decryption data for the remaining locations in the decryption map and decrypting each of the pixels using the corresponding decryption key.

21. A system for processing encrypted image data, comprising:
a first storage area to store encrypted input image data corresponding to at least a portion of a video frame;
an encryption map containing data for reversibly decrypting the encrypted input image data; and
a graphics processor to process the encryption map and the encoded input image data to thereby generate decrypted output image data.

22. The system of claim 21 wherein the encryption map data is encryption key data.

23. The system of claim 21 wherein the encryption input image data comprises a plurality of pixels and the encryption map has a decryption key corresponding to each respective pixel of the input image data, the graphics processor decrypting each of the pixels using the corresponding decryption key.

24. The system of claim 21 wherein the encryption input image data comprises a plurality of pixels and the encryption map has a decryption key corresponding to a plurality of the pixels of the input image data, the graphics processor decrypting each of the pixels using the corresponding decryption key.

25. The system of claim 21 wherein the encryption input image data comprises a plurality of pixels and the encryption map has a plurality of storage locations corresponding to each of the plurality of pixels in the input image data and contains active decryption data in at least one location in the encryption map, the remaining locations in the encryption map containing decoy decryption data.

26. The system of claim 25 wherein the active decryption data in the at least one location is stored in a predetermined one of the plurality of locations within the encryption map.

27. The system of claim 25 wherein the active decryption data in the at least one location is stored in a pseudo-random one of the plurality of locations within the encryption map.

28. The system of claim 21 wherein the encrypted input image data comprises a plurality of pixels and the encryption map has a plurality of storage locations corresponding to each of the plurality of pixels in the input image data and contains active decryption data in at least one location in the encryption map, the graphics processor determining decryption data for the remaining locations in the encryption map and decrypting each of the pixels using the corresponding decryption data.

29. The system of claim 21 wherein the encrypted input image data comprises a plurality of pixels, the graphics processor scaling the encrypted image data using a predetermined scaling process and scaling the encryption map using the same predetermined scaling process.

30. The system of claim 21 wherein the encrypted input image data is video data comprising a frame having first and second interlaced fields, the graphics processor de-interlacing the first and second fields by individually scaling the first and second fields to generate first and second de-interlaced frames, the graphics processor further scaling the encryption map to generate first and second encryption maps corresponding to the generate first and second de-interlaced frames.

31. The system of claim 21 wherein the encrypted input image data comprises three dimensional graphics data, the graphics processor processing the encrypted image data using a texture map and further processing the encryption map as a texture map.

32. The system of claim 21 wherein the encrypted input image data comprises a video frame compressed in accordance with a motion pictures expert group (MPEG) standard wherein the graphics processor processes the MPEG compressed encrypted video frame and the encryption map to thereby generate decrypted output image data.

33. The system of claim 32 wherein the decrypted output image data is a MPEG compressed encrypted video frame, the graphics processor further processing the MPEG compressed encrypted video frame to generate a decompressed video frame.

34. A method for processing image data for display on a video display device, comprising:
storing input image data corresponding to at least a portion of a video frame;
generating an encryption map to reversibly encrypt the input image data; and
processing the input image data and the encryption map to thereby generate encrypted output image data.

35. The method of claim 34 wherein the encryption map comprises encryption key data.

36. The method of claim 34 wherein the input image data comprises a plurality of pixels and the encryption map has an encryption key corresponding to each respective pixel of the input image data, wherein processing the input image data comprises encrypting each of the pixels using the corresponding encryption key.

37. The method of claim 34 wherein the input image data comprises a plurality of pixels and the encryption map has an encryption key corresponding to a plurality of the pixels of the input image data, wherein processing the input image data comprises encrypting each of the pixels using the corresponding encryption key.

38. The method of claim 34 wherein the input image data comprises a plurality of pixels and the encryption map has a plurality of storage locations corresponding to each of the plurality of pixels in the input image data and contains active encryption data in at least one location in the encryption map, the remaining locations in the encryption map containing decoy encryption data not used to encrypt the input image data.

39. The method of claim 34 wherein the input image data comprises a plurality of video scan lines and the encryption map has an encryption key corresponding to each of the scan lines of the input image data, wherein processing the input image data comprises encrypting each of the scan lines using the corresponding encryption key.

40. The method of claim 34 wherein the input image data is a sequence of video frames each comprising a plurality of pixels and the encryption map comprises a plurality of encryption maps corresponding to the respective video frames wherein each encryption map has an encryption key corresponding to each respective pixel of the corresponding video frame.

41. The method of claim 34 wherein the input image data is a sequence of video frames each comprising a plurality of pixels and the encryption map comprises a plurality of encryption maps corresponding to the respective video frames wherein each encryption map has an encryption key corresponding to a plurality of the pixels of the corresponding video frame.

42. The method of claim 34 wherein the input image data is a sequence of video frames and processing the input image data comprises using the encryption map to encode more than one of the sequence of video frames.

43. The method of claim 34 wherein the video frame is compressed in accordance with a motion pictures expert group (MPEG) standard wherein processing the input image data comprises processing the MPEG compressed video frame and the encryption map to thereby generate encrypted output image data.

44. The method of claim 34, further comprising processing the encrypted output image data and decryption map data to thereby generate decrypted output image data.

45. The method of claim 44 wherein the decryption map is decryption key data.

46. The method of claim 44 wherein the decryption map is identical to the encryption map.

47. A method for processing encrypted image data, comprising:
storing encrypted input image data corresponding to at least a portion of a video frame;
storing an encryption map containing decryption data for decrypting the encrypted input image data; and
processing the encryption map and the encrypted input image data to thereby generate decrypted output image data.

48. The method of claim 47 wherein the encryption map data is encryption key data.

49. The method of claim 47 wherein the encryption input image data comprises a plurality of pixels and the encryption map has a decryption key corresponding to each respective pixel of the input image data, and processing the encryption map and encrypted input image data comprises decrypting each of the pixels using the corresponding decryption key.

50. The method of claim 47 wherein the encryption input image data comprises a plurality of pixels and the encryption map has a decryption key corresponding to a plurality of the pixels of the input image data, and processing the encryption map and encrypted input image data comprises decrypting each of the pixels using the corresponding decryption key.

51. The method of claim 47 wherein the encrypted input image data comprises a plurality of pixels and the encryption map has a plurality of storage locations corresponding to each of the plurality of pixels in the input image data and contains active decryption data in at least one location in the encryption map, the remaining locations in the encryption map containing decoy decryption data.

52. The method of claim 47 wherein the active decryption data in the at least one location is stored in a predetermined one of the plurality of locations within the encryption map.

53. The method of claim 47 wherein the active decryption data in the at least one location is stored in a pseudo-random one of the plurality of locations within the encryption map.

54. The method of claim 47 wherein the encrypted input image data comprises a plurality of pixels and the encryption map has a plurality of storage locations corresponding to each of the plurality of pixels in the input image data and contains active decryption data in at least one location in the encryption map, the method further comprising determining decryption data for the remaining locations in the encryption map and decrypting each of the pixels using the corresponding decryption data.

55. The method of claim 47 wherein the encrypted input image data comprises a plurality of pixels, the method further comprising scaling the encrypted image data using a predetermined scaling process and scaling the encryption map using the same predetermined scaling process.

56. The method of claim 47 wherein the encrypted input image data is video data comprising a frame having first and second interlaced fields, the method further comprising de-interlacing the first and second fields by individually scaling the first and second fields to generate first and second de-interlaced frames, and scaling the encryption map to generate first and second encryption maps corresponding to the generate first and second de-interlaced frames.

57. The method of claim 47 wherein the encrypted input image data comprises three dimensional graphics data, the method further comprising processing the encrypted image data using a texture map and further processing the encryption map as a texture map.

58. The method of claim 47 wherein the encrypted input image data comprises a video frame compressed in accordance with a motion pictures expert group (MPEG) standard, wherein processing the encryption map and the encrypted input image data comprises processing the MPEG compressed encrypted video frame and the encryption map to thereby generate decrypted output image data.

59. The method of claim 58 wherein the decrypted output image data is a MPEG compressed encrypted video frame, the method further comprising processing the MPEG compressed encrypted video frame to generate a decompressed video frame.

60. A computer-readable media that causes a computer to process image data for display on a video display device by performing the steps of:
storing input image data corresponding to at least a portion of a video frame;
generating an encryption map to reversibly encrypt the input image data; and
processing the input image data and the encryption map to thereby generate encrypted output image data.

61. The computer-readable media of claim 60 wherein the encryption map comprises encryption key data.

62. The computer-readable media of claim 60 wherein the input image data comprises a plurality of pixels and the encryption map has an encryption key corresponding to each respective pixel of the input image data, the computer-readable media causing the computer to encrypt each of the pixels using the corresponding encryption key.

63. The computer-readable media of claim 60 wherein the input image data comprises a plurality of pixels and the encryption map has an encryption key corresponding to a plurality of the pixels of the input image data, the computer-readable media causing the computer to encrypt each of the pixels using the corresponding encryption key.

64. The computer-readable media of claim 60 wherein the input image data comprises a plurality of pixels and the encryption map has a plurality of storage locations corresponding to each of the plurality of pixels in the input image data and contains active encryption data in at least one location in the encryption map, the remaining locations in the encryption map containing decoy encryption data not used to encrypt the input image data.

65. The computer-readable media of claim 60 wherein the input image data comprises a plurality of video scan lines and the encryption map has an encryption key corresponding to each of the scan lines of the input image data, the computer-readable media causing the computer to encrypt each of the scan lines using the corresponding encryption key.

66. The computer-readable media of claim 60 wherein the input image data is a sequence of video frames each comprising a plurality of pixels and the encryption map comprises a plurality of encryption maps corresponding to the respective video frames wherein each encryption map has an encryption key corresponding to each respective pixel of the corresponding video frame.

67. The computer-readable media of claim 60 wherein the input image data is a sequence of video frames each comprising a plurality of pixels and the encryption map comprises a plurality of encryption maps corresponding to the respective video frames wherein each encryption map has an encryption key corresponding to a plurality of the pixels of the corresponding video frame.

68. The computer-readable media of claim 60 wherein the input image data is a sequence of video frames and the computer-readable media causes the computer to use the encryption map to encode more than one of the sequence of video frames.

69. The computer-readable media of claim 60 wherein the video frame is compressed in accordance with a motion pictures expert group (MPEG) standard wherein the computer-readable media causes the computer to process the MPEG compressed video frame and the encryption map to thereby generate encrypted output image data.

70. The computer-readable media of claim 60, further comprising instruction that cause the computer to process the encrypted output image data and a decryption map data to thereby generate decrypted output image data.

71. The computer-readable media of claim 70 wherein the decryption map is decryption key data.

72. The computer-readable media of claim 70 wherein the decryption map is identical to the encryption map.

73. computer-readable media that causes a computer to process encrypted image data for display on a video display device by performing the steps of:
storing encrypted input image data corresponding to at least a portion of a video frame;
storing an encryption map containing decryption data for decrypting the encrypted input image data; and
processing the encryption map and the encrypted input image data to thereby generate decrypted output image data.

74. The computer-readable media of claim 73 wherein the encryption map data is encryption key data.

75. The computer-readable media of claim 73 wherein the encryption input image data comprises a plurality of pixels and the encryption map has a decryption key corresponding to each respective pixel of the input image data, and processing the encryption map and encrypted input image data comprises decrypting each of the pixels using the corresponding decryption key.

76. The computer-readable media of claim 73 wherein the encryption input image data comprises a plurality of pixels and the encryption map has a decryption key corresponding to a plurality of the pixels of the input image data, and processing the encryption map and encrypted input image data comprises decrypting each of the pixels using the corresponding decryption key.

77. The computer-readable media of claim 73 wherein the encrypted input image data comprises a plurality of pixels and the encryption map has a plurality of storage locations corresponding to each of the plurality of pixels in the input image data and contains active decryption data in at least one location in the encryption map, the remaining locations in the encryption map containing decoy decryption data.

78. The computer-readable media of claim 73 wherein the active decryption data in the at least one location is stored in a predetermined one of the plurality of locations within the encryption map.

79. The computer-readable media of claim 73 wherein the active decryption data in the at least one location is stored in a pseudo-random one of the plurality of locations within the encryption map.

80. The computer-readable media of claim 73 wherein the encrypted input image data comprises a plurality of pixels and the encryption map has a plurality of storage locations corresponding to each of the plurality of pixels in the input image data and contains active decryption data in at least one location in the encryption map, the method further comprising determining decryption data for the remaining locations in the encryption map and decrypting each of the pixels using the corresponding decryption data.

81. The computer-readable media of claim 73 wherein the encrypted input image data comprises a plurality of pixels, the computer-readable media further comprising instructions to cause the computer to scale the encrypted image data using a predetermined scaling process and to scale the encryption map using the same predetermined scaling process.

82. The computer-readable media of claim 73 wherein the encrypted input image data is video data comprising a frame having first and second interlaced fields, the computer-readable media further comprising instructions to cause the computer to de-interlace the first and second fields by individually scaling the first and second fields to generate first and second de-interlaced frames, and to scale the encryption map to generate first and second encryption maps corresponding to the generate first and second de-interlaced frames.

83. The computer-readable media of claim 73 wherein the encrypted input image data comprises three dimensional graphics data, the computer-readable media further comprising instructions to cause the computer to process the encrypted image data using a texture map and further process the encryption map as a texture map.

84. The computer-readable media of claim 73 wherein the encrypted input image data comprises a video frame compressed in accordance with a motion pictures expert group (MPEG) standard, wherein processing the encryption map comprises processing the MPEG compressed encrypted video frame and the encryption map to thereby generate decrypted output image data.

85. The computer-readable media of claim 84 wherein the decrypted output image data is a MPEG compressed encrypted video frame, the computer-readable media further comprising instructions to cause the computer to process the MPEG compressed encrypted video frame to generate a decompressed video frame.
